(19) United States
(12) Patent Application Publication
(10) Pub. No.: US 2009/0028300 A1
(43) Pub. Date: Jan. 29, 2009

(54) NETWORK COMMUNICATION SYSTEMS INCLUDING VIDEO PHONES

(76) Inventor: Tom McLaughlin, Salt Lake City, UT (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/180,278

(22) Filed: Jul. 25, 2008

Related U.S. Application Data
(60) Provisional application No. 60/962,021, filed on Jul. 25, 2007.

(51) Int. Cl. H04M 11/00

(52) U.S. Cl. 379/52

(57) ABSTRACT

An inbound call for a hearing impaired user may be routed to a server. The server may determine a destination for the call and obtain caller identifying information from the incoming call. A pop-up prompt may be displayed on a computing device of one or more recipients of the call. The pop-up prompt may comprise one or more input to allow the intended recipient(s) of the call to handle the incoming call by answering the call using a video relay service (VRS) agent, a text relay service agent (TRS), a messaging service, or the like. If a hearing impaired user answers the call, one of a plurality of in-house or remote VRS or TRS agents may be selected to provide relay services for the call. Outbound calls made by the hearing impaired user may be similarly assigned to one of a plurality of VRS or TRS agents.

### RELATED APPLICATIONS

This application claims the benefit under 35 U.S.C>§ 119(e) of U.S. Provisional Patent Application No. 60/962,021 entitled “Network Communication Systems Including Video Phones,” filed on Jul. 25, 2007, which is incorporated by reference in its entirety.

### TECHNICAL FIELD

The present invention relates generally to communication systems and specifically to Video Relay Services within a communication system.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of one embodiment of a system for providing communications services;

FIG. 2 is a flow diagram of one embodiment of a method for providing inbound call communications services; and

FIG. 3 is a flow diagram of one embodiment of a method for providing output call communications services.

### DETAILED DESCRIPTION OF PREFERRED EMBODIMENTS

Many hearing impaired persons use sign language to communicate. Video Relay Services (VRS) are telephone services that allow hearing impaired persons to use sign language to communicate with a hearing person, when the hearing person is using a voice telephone. In a VRS call, a voice phone call is set up between a hearing person and a sign language interpreter (e.g., VRS agent), and a video conferencing connection is set up between the VRS agent and the hearing impaired person. As the hearing person talks, the VRS agent signs to the hearing impaired person, and as the hearing impaired person signs, the VRS agent voices to the hearing person what the hearing impaired person is saying.

The video link between the hearing impaired person and the VRS agent may be PC-based to a desktop computer, or may use a stand-alone “video phone” device. For security, system maintenance, or other reasons, some organizations prefer to use video phones rather than PCs for VRS services.

However, current communication systems using a video phone combined with VRS services suffer from several significant drawbacks. For example, VRS services typically must be manually provisioned by the hearing impaired or hearing person. Video phone services often require the user wait and watch the screen until a VRS agent accepts the call. Also, video phones are usually tied to a single VRS provider, which may cause delays to be excessive. Moreover, many VRS providers do not provide certain amenities, such as a contact lists, online phone books, text chat services, call screening, or TTY call support. In addition, video phones only have one response when a call is not answered and the VRS number is tied to a single video phone machine.

Several embodiments of the present invention are designed to overcome these and other limitations of current video phone communication systems.

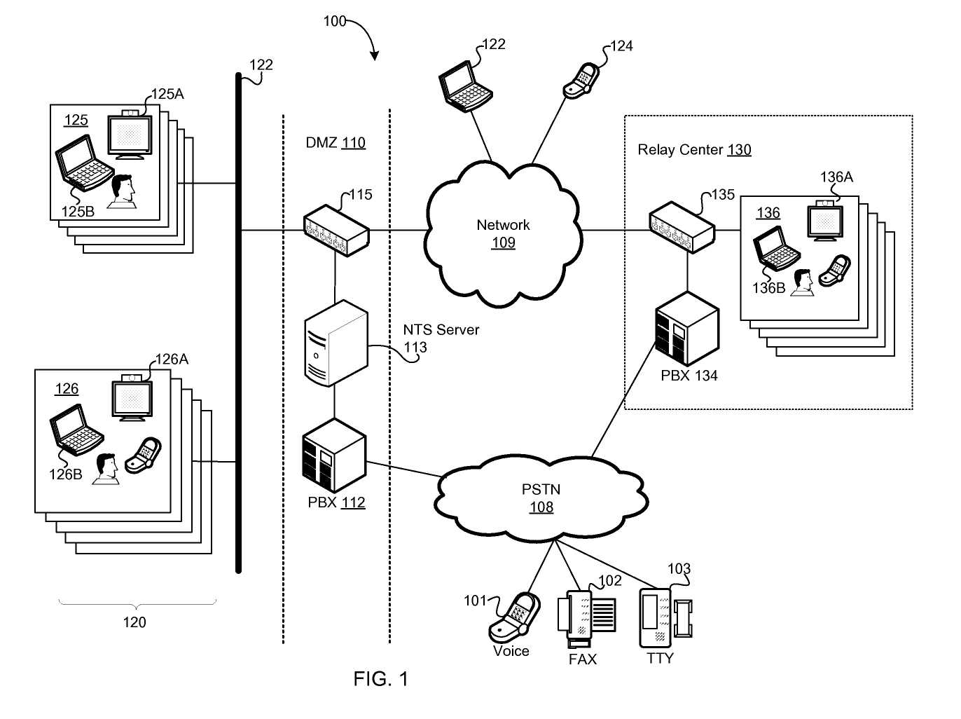

FIG. 1 is a block diagram of one embodiment of a system 100 for provisioning communication services. In the FIG. 1 embodiment, a server-based network is combined with video phone technology.

The communication system 100 may be configured to serve one or more hearing impaired persons and one or more hearing persons. However, this embodiment is merely for illustrative purposes, and the scope of the invention should not be limited by any one embodiment.

A voice caller 101 may initiate communication by dialing a number (referred to as a “One-Nbr” herein) associated with a particular user 125A or group of users 125A. The particular user 125A and/or members of the group of users 125A may comprise one or more hearing impaired persons. The One-Nbr may be a number (or other network identifier) associated with the intended recipient of the communication rather than that of an in-house or third-party relay service. The One-Nbr may include, but is not limited to: a PSTN number (e.g., phone number), an IP address, a email address, a network-specific identifier (e.g., a Skype® address), or any other address known in the art. Unlike traditional systems, where a voice caller must call to a VRS service provider (not shown) in order to initiate a call to a hearing impaired person or a group comprising hearing impaired persons, the One-Nbr may be a number associated with the user 125A or group of users 125A rather than a particular VRS service provider. As such, if a hearing person receives the call, the call may be routed directly to the hearing person. If a hearing impaired person answers the call, a relay service may be provisioned to service the call (as will be discussed below).

The One-Nbr may be associated with the system 100, allowing the PSTN 108 to route the voice call to a private branch exchange (PBX) 112 communicatively coupled to the PSTN 108.

The PBX 112 routes the voice call to a Network Telephony Server (NTS) server 113. In one embodiment, routing the call is based on the particular number (One-Nbr) dialed. In another embodiment, the NTS services are provided by an external server, and routing the call then involves forwarding the call to the remote NTS server (not shown). The NTS server 113 may comprise a computing device, such as a server computer comprising storage media (e.g., removable disc, fixed disc, optical media, memory, and the like). The storage media (not shown) of the NTS server 113 may comprise computer readable instructions to configure the NTS server 113 to provide the communications services described below. The instructions may comprise pre-compiled programming code, interpreted programming code, script instructions, or the like.

As shown in FIG. 1, the PBX 112 and the NTS server 113 may be communicatively coupled to one of a plurality of networks (e.g., PSTN 108, Network 109, and Network 122) in a so-called network “DMZ” or “perimeter network” 110. The DMZ 110 may be a physical or logical subnetwork that comprise and/or exposes services (e.g., PBX 112 and/or NTS server 113) to larger, untrusted network(s), such as network 109 and/or PSTN 108. The DMZ 110 may add an additional layer of security to a network 122 of a particular organization 120 (discussed below), since an external attacker (e.g., from network 109 and/or PSTN 108) may only have access to equipment in the DMZ 110, rather than the whole of the network 122.

Once the NTS server 113 receives the call from the PBX 112, it may activate a script to handle the call. The script may comprise a voice/text “script.” In one embodiment, this voice/text script is a set of encoded instructions directing the NTS server 113 to read the number (e.g., the One-Nbr) dialed by the voice caller 101, as well as the number of the voice caller 101 (e.g., the number from which the call originated). In another embodiment, the script can include instructions to the voice caller 101: for example, the audio prompt “Please press 1.”

Furthermore, the NTS server 113 may be configured to detect and accept several types of calls, such as calls from a voice caller 101, calls from a fax 102, calls from a Teletype (TTY) device 103, and the like. As such, the NTS server 113 may be configured to determine a type of the call received (e.g., whether the call is a voice call, a fax, a TTY, or the like). The NTS server 113 may make this determination by detecting tones on the line, such as voice sounds, fax tones, TTY, modem, or the like. Therefore, NTS server 113 may comprise tone detectors (not shown) configured to identify distinctive tones associated with particular call types (e.g., sound frequencies). In addition, the NTS server 113 may play a voice recording to prompt a voice caller 101 or other device (e.g., 102 or 103) to provide input to allow the NTS server 113 to identify the call type. For example, a voice caller 101 may be instructed to press a key on their phone, or simply say something by voice to solicit those tones, which would identify the call as a voice call. In another embodiment, the server sends TTY, text tones, and/or fax tones to solicit a text response from a TTY call or a fax tone response. The NTS server 113 may also have a scripted response if no recognizable sounds are returned.

As will be discussed below, the NTS server 113 may be configured to handle various types of calls (e.g., fax calls, TTY calls, and the like) in different ways. The NTS server 113 may be configured to consult internal tables, databases, or external databases or other configuration information to determine proper handling of the detected call type.

To handle a voice call received from a voice caller 101, the NTS server 113 may be configured to determine a link or “route” for the voice call based on the information provided by the number dialed by the voice caller 101. The corresponding information may include, but is not limited to: a user's 125 or group of users' 125 call handling preferences; default actions for the call type; or the like.

The NTS server 113 may be connected to a network 122 of a particular organization 120. The network 122 may connect the NTS server 113 with one or more users 125 in the organization 120. Although FIG. 1 shows users 125 within an organization 120, one skilled in the art would recognize that the system 100 could be configured into any network organization known in the art. For example, the NTS server 113 could be communicatively coupled to single users 125 via respective network(s) 122, could be communicatively coupled to a plurality of organizations 120 via a plurality of networks 122, and the like.

Each of the users 125 in the organization 120 may be communicatively coupled to the NTS server 113 via the network 122 using a respective computing device 125B, a video phone 125A, and/or other communications device (not shown) (e.g., IP telephone, TTY device, fax, or the like).

The network 122 may comprise a local area network (LAN), a wide area network (WAN), a virtual private network (VPN), or the like. Alternatively, or in addition, the network 122 may comprise a cellular data network, a wireless network (e.g., IEEE 802.11, Bluetooth®, or the like), or any other network infrastructure or combination of networks known in the art.

As discussed above, upon receiving an incoming voice call from a voice callers 101, the NTS server 113 may be configured to determine routing information for the call (e.g., a network address of the user(s) 125 associated with the number dialed by the voice caller or the like), determine caller-ID information associated with the voice caller 101, and the like.

The NTS server 113 may use this and other information to generate a “One-Nbr pop-up” prompt to notify the one or more users 125 of the incoming call. The prompt may be transmitted to the one or more users 125 via the network 122. The popup prompt may be displayed on a respective computing device 125B of the selected one or more users. As used herein, a computing device 125B may include, but is not limited to: a personal computer, a mobile computer (e.g., a laptop computer, palmtop computer, a tablet computer, or the like), a personal digital assistant (PDA), a mobile phone, a smart phone, or the like. Accordingly, the computing device 125B may be any computing device capable of communicating with the NTS server 113 over the network 122.

The user 125 may have a plurality of such computing devices 125B, in which case, the NTS server 113 may link or forward the One-Nbr pop-up prompt to one or more of the devices 125A capable of receiving the prompt. As an illustrative example, if the user 125 answering a voice caller 101 has a voice phone and is not hearing impaired, the NTS server 113 may link or forward the inbound voice call to the voice phone device 125A of the user 125. In one or more users in a group of users 125 is hearing impaired, the NTS server 125 may transmit notification of the incoming call as both One-Nbr pop-up prompt(s) to one or more hearing impaired users 125 and as voice calls to one or more hearing users 125. Similarly, where a particular user 125 comprises both hearing impaired and hearing individuals (e.g., user 125 may represent a household, office location, or the like). The NTS server 113 may simultaneously transmit notification of the incoming call to the user 125 as one or more One-Nbr pop-up prompt(s) and voice call(s).

If one or more users 125 do not have a compatible computing device 125B capable of receiving the One-Nbr pop-up prompt, the NTS server 113 may link a relay operator 126 or 136 into the call to mediate the call. For example, if the user 125 answering the inbound call is hearing impaired, and has a video phone device 125A or TTY interface (not shown), the NTS server 113 may link a relay agent (e.g., an agent 126 or 136 discussed below) to the call. The relay agent 126 or 136 may comprise a human relay agent (e.g., a translator) to perform a relay/translation function between the voice caller 101 and the hearing impaired user(s) 125. In this way, the hearing impaired user(s) 125 may communicate with the voice caller 101.

However, if the one or more users 125 associated with the call do have one or more computing devices 125B configured to communicate with the NTS server 113, the One-Nbr pop-up prompt may provide notice of the incoming call. The One-Nbr pop-up prompt may present the user(s) 125 with notification of the incoming call and provide the user(s) the option of responding to the call (or directing the NTS server 113 to handle the call in other ways).

In some embodiments, possible responses to the One-Nbr pop-up prompt include, but are not limited to: answering the call using a relay agent (e.g., a VRS agent or TRS agent); instructing the NTS server 113 to take a message using a relay agent (e.g., taking a video message using a VRS agent or a text message using a TRS agent); transferring the call to another phone number; transferring the call to a voicemail recipient for further processing; or the like.

As discussed above, the One-Nbr pop-up prompt transmitted by the NTS server 113 may comprise information about the incoming call, such as caller-ID information identifying the voice caller 101 or the like. The information may be obtained from a Contact Database (not shown), a Customer Database (not shown), a Public or Private Database (not shown), or the like. The prompt may comprise any caller identifying information known in the art including, but not limited to: an address or location of the voice caller 101; a number of the voice caller 101; contact information for the voice caller 101; a photograph of the voice caller 101, and the like.

If the user 125 is not available to take the incoming call, the NTS server 113 may be configured to route the call to a relay services agent (e.g., agent 126 or 136) who may take a message from the voice caller 101. For example, the relay agent 126 or 136 may receive the voice caller's 101 message and leave a video or text message for the user 125.

As discussed above, the One-Nbr pop-up prompt may be sent to one or more users 125 via the network 122, any one of which may respond to the call. The prompt may comprise an input interface (e.g., a button) to play a recorded voice message to the voice caller 101. The message may provide instructions to the caller 101 to inform the caller 101 that he/she has reached a hearing impaired user 125 and that the call is in the process of being serviced. As such, useful messages may include asking the voice caller to “please wait” while relay services (e.g., TRS and/or VRS) are obtained for the call. In addition, a custom greeting message may be played to the voice caller 101. The custom greeting message may be determined using the caller-ID information in the prompt. For example, a user 125 may commonly receive calls from family members, business associates, or the like. The user 125 may establish a custom greeting script for one or more of these common callers, which may be played responsive to identification of the callers using the caller-ID information associated with the prompt.

If a user 125 takes the call, the prompt is cleared from any remaining user computing devices 125A. As discussed above, if the user (or user(s)) 125 are unavailable to take the call (e.g., the recipient user or users 125 are not logged into the NTS server 113), the NTS server 113 may divert the call to a “no answer” script, to one or more other phones, or to take other script-driven action(s). For example, the caller 101 may leave a video message for a particular user 125 in a user-level inbox, a group of users 125 in a group level inbox, or the like.

If a hearing impaired person 125 answers the call, the user 125 may select one of a plurality of relay services available for supporting the call. Such services may include, but are not limited to: VRS services wherein a video call may be established between the user 125 and a VRS agent (e.g., VRS agent 126) who may act as an intermediary between the hearing impaired user 125 and the caller 101; TRS services wherein the hearing impaired user 125 wherein a text-based session is established between the user 125 and a TRS agent (e.g., TRS agent 126) who may act as an intermediary between the hearing impaired user 125 and the caller 101; or the like. Although VRS and TRS services are discussed herein, one skilled in the art would recognize that any type of communication service could be used under the teachings of this disclosure.

The options available to the user 125 in the One-Nbr pop-up prompt may be determined by the NTS server 113. For example, in some embodiments, the NTS server 113 may be configured to limit the number of current VRS video calls serviced on the network 122 at any one time. This limit may prevent overload of the network 122 by VRS traffic, which may degrade the service of all of the VRS calls on the network 122 and/or affect other traffic on the network 122. Alternatively, the NTS server 113 may be configured to enforce a Quality of Service (QOS) metric and/or may monitor the network 122 to determine whether bandwidth capacity is available to support VRS services for the current call. If VRS services for the new call would exceed the pre-set limit and/or the network 124 lacks the bandwidth to service the call, the NTS server 113 may be configured to prevent the user 125 from selecting VRS services for the call (e.g., by disabling the VRS option in the prompt or the like), and/or may switch the call to a lower bandwidth option, such as a TRS services or the like.

If the user 125 selects relay service (VRS or TRS), the request is transmitted to the NTS server 113 via the network 122. Responsive to the request, the NTS server 113 may be configured to identify a relay agent 126 or 136 to service the call. The NTS server 113 may be configured to select from a plurality of in-house VRS agents 126 communicatively coupled to the user 125 and NTS server 113 on the network 122 and/or a plurality of remote relay agents 136 provided by a remote relay center 130.

The NTS server 113 may be configured to access the relay center 130 via a network 109, which may comprise a Wide Area Network (WAN), the Internet, or the like. The relay center 130 may comprise a gateway 132 (e.g., a video and/or text router gateway) configured to receive requests for relay services from the NTS server 113 and to route such requests to selected relay agents 136 provided by the relay center 130.

In some embodiments, the NTS server 113 may prefer using in-house relay agents 126. As such, the NTS server 113 may query the in-house relay agents 126 for available agents 126 before querying the relay center 130 for such services. Similarly, the NTS server may be communicatively coupled to a plurality of relay centers 130 over the network 109. The NTS server 113 may prefer certain relay centers 130. As such, the NTS server 113 may query the plurality of relay centers 130 in order of their relative preference.

The NTS server 113 may be configured to search for in-house relay agents 126 by determining whether the agents 126 are logged into the NTS server 113 and/or whether the respective agents 126 are currently servicing a call. If one or more agents 126 are available, the agent(s) may be selected to service the call. Selection may comprise transmitting an acceptance prompt to a computing device 126B of the agent 126, transmitting the call to a video phone 126A of the agent 126, transmitting the call to a TTY device (not shown) of the agent 126, or the like.

The NTS server 113 may be communicatively coupled to the network 109 using a gateway/firewall 15. The NTS server 113 may communicate with one or more remote relay centers 130 using the network 109. The NTS server 113 may determine the remote relay agent 136 availability by querying one or more relay centers 130. In some embodiments, the relay center 130 may be configured to respond to requests for relay services from the NTS server 113. In other embodiments, the NTS server 113 may be configured to query the remote agents 136 directly, over the network 109.

In some embodiments, the NTS server 113 may be coupled to a Transmission Control Protocol/Internet Protocol (TCP/IP) gateway 115. The NTS server 113 may use the gateway 115 to query for an available remote agent 136. The TCP/IP gateway 115 may comprise a Text Gateway to provide a flexible means for conveying agent requirements to the relay center 130. The agent requirements may comprise desired relay agent 136 skills, such as languages spoken by the relay agent 136 or the like. In other embodiments, the NTS server 113 may dial a unique phone number to reach a remote relay center 130 via the PSTN 108. In this case, the relay center 130 may comprise a PBX 134 configured to receive and process the call.

Once the NTS server 113 identifies a relay agent 126 or 136 to service the call, the NTS server 113 and the selected relay agent 126 or 136 exchange call-setup information. The call-setup information may allow the selected relay agent 126 or 136 to establish a call with the hearing impaired user 125 and voice caller 101.

As discussed above, the relay agent 126 or 136 may be used to provide VRS services or TRS services depending upon user 125 preferences and/or network conditions.

To establish a VRS call with a relay agent 126 or 136, the NTS server 113 may instruct the relay agent 126 or 136 to initiate a video call to the video phone 125B of the hearing impaired person 125 and to initiate a voice call to the voice caller 101. Accordingly, the hearing impaired user 125 and the voice caller 101 may become linked to the relay agent 126 or 136. In some embodiments, an automatic link may be formed by creating a separate phone call to the relay agent 126 or 136, and then using a technique, such as an Integrated Services Digital Network (ISDN) Two B Channel Transfer (TBCT) to signal the PSTN 108 central office to link the voice caller's 101 call to the relay agent's 126 or 126 call and to drop off the NTS server 113. Accordingly, the call between the relay agent 126 or 136 may be provisioned automatically without intervention by the hearing impaired user(s) 125 and/or voice caller 101.

In another embodiment, the relay agent 126 or 136 may be provided a phone number (e.g., via the network 122 or gateway 115) that arrives at the NTS server 113. This number may be “pre-mapped” to the particular call identifier to be serviced by the relay agent 126 or 136. In this approach, the relay agent 126 or 136 outdials to the NTS server 113 to link to the voice caller 101. Once in place, NTS server 113 can continue to host the audio conference call between the relay agent 136, the voice caller 101, and one or more hearing impaired users 125. Alternatively, at this point NTS server 113 can use an ISDN technique, such as TBCT to link the voice caller's 101 call to the relay agent 126 or 136, so that NTS server 113 may drop out of the call.

The call established by the NTS server 113 may include several devices. For example, an n-way audio conference call between a relay agent 126 or 136, the voice caller 101 (e.g., the hearing person), and one or more hearing impaired persons 125. The call may reside at a remote relay 130, within an organization 120 of the user 125, be serviced by the NTS server 113, or may reside in a third-party audio conference system (not shown).

If the call is hosted by the relay agent (e.g., an in-house relay agent 126 or a remote relay center 130), the phone number and possible extensions used by the agent 126 or 136 may be sent to the NTS server 113. The NTS server 113 may transfer the voice caller 101 to the appropriate phone number to connect the voice caller 101 to the relay agent 126 or 136. If the call is hosted by the NTS server 113, the NTS server 113 provides a phone number to the relay agent 126 or 136. The relay agent 136 may then dial out to the number of the NTS server 113, which will link or conference the relay agent 126 or 136 to the voice caller 101.

The NTS server 113 may use a phone outcall mechanism to provide additional information to the relay agent 126 or 136 to setup the call. The outcall may comprise a conventional PSTN call (e.g., using PSTN network 108 over analog or digital T1/E1 lines). Alternatively, or in addition, the outcall may comprise a VoIP (Voice over IP) call over network 122 or 109. The additional information provided to the replay center may comprise the IP address of the targeted video phone 125A of the user(s) 125 (e.g., to setup a video call between the relay agent 126 or 136 and the user(s) 125). The additional information may also comprise an IP address of one or more computing devices 125B of the user(s) 125 (e.g., to setup a chat session between the relay agent 126 or 136 and the user(s) 125), user names of the user(s) 125, phone numbers or other identification of the user(s) 125 and/or the voice caller 101, or any other identifying information needed to establish a link to the hearing impaired person's 125 video phone 125A, computing device 125B, or other communication device.

After exchanging the required information, the NTS server 113 may setup the call (or instruct the relay agent 126 or 136 to setup the call) between the user(s) 125, the relay agent 126 or 136, and the voice caller. As discussed above, the communication channel between the user(s) 125 and the relay agent 126 or 136 may comprise a video phone channel (e.g., using respective video phone(s) 125A of the user(s) 125) and/or a text chat channel (e.g., using respective computing device(s) 125B of the user(s) 125). Accordingly, in some embodiments, a video and/or text record of the conversation may be saved and stored by the NTS server 113.

Although the above description of FIG. 1 describes providing relay services to a voice caller 101 accessing one or more user(s) 125 via a PSTN 108, other communications systems may be used under the teachings of this disclosure. For example, a user of an Internet phone service, such as Skype® or the like, may access a user 125 using the system 113. In this case, the user 122 may enter an address of a user 125 into an Internet communication program (e.g., Skype® or the like). The request may be routed over the network 109 to the NTS server 113 (e.g., the NTS server 113 may be configured to receive the incoming call intended for the user 125).

Upon receiving the incoming call, the NTS server may present a One-Nbr pop-up prompt on one or more computing devices 125B of the user(s) substantially as described above. Upon receiving a request to answer (e.g., via user 125 selection of an “answer” input on the prompt), the NTS server 113 may determine a relay agent 126 or 136 for use in servicing the call. The call may be setup between the relay agent 126 or 136 substantially as described above (e.g., the NTS server 113 may transmit call setup information to/from the caller relay agent 126 or 136, may host a conference call between the relay agent 126 or 136 and the user 122, or the like). The NTS server 113 may also be configured to provision relay services for voice over IP (VOIP) phone users 124 or the like.

The system 100 depicted in FIG. 1 may also be configured to provide outbound call services for the users 125. In one embodiment, a hearing impaired user 125 may initiate a phone call to a voice call recipient 101 using his/her respective computing device 125B. The computing device 125B may comprise a software application (not shown) configured to interface with the NTS server 113. The application may comprise a phonebook or other contacts database to assist the user 125 in placing the call to the voice call recipient 101.

Upon selection of an entry in the phone book (or manual entry of a phone number or other recipient identifier), a call request may be transmitted to the NTS server 113. As discussed above, in some embodiments, the NTS server 113 may be configured to manage the traffic generated on the network 122. Accordingly, the NTS server 113 may limit the number of concurrent VRS calls on the network 122. If a request by a particular user 125 would exceed the limit (or exceed a QOS metric on the network 122), the user 125 may be prompted to either wait and try the call later, or to use a lower-bandwidth option, such as TRS or the like.

Responsive to the user request, the NTS server 113 may identify an available relay agent 126 or 136 to service the call. The relay agent 126 or 136 may be an in-house agent 126 or a remote agent 136 provided by the remote relay center 130. As discussed above, although FIG. 1 depicts a single remote relay center 130, one skilled in the art would appreciate that the NTS server 113 may be communicatively coupled to any number of remote relay centers 130 via the network 109.

After determining a relay agent 126 or 136, the NTS server 113 may provide call setup information to the selected relay agent 126 or 136 substantially as described above. The NTS server 113 may identify the call recipient from the request information (e.g., the phone number of the caller 101 the user 125 wishes to reach). The call setup information may comprise an identifier to allow the agent 126 or 136 to place a video call to a video phone 125A and/or to establish a chat session to a computing device 125B of the user 125. In addition, the call setup information may allow the relay agent 126 or 136 to contact the intended voice call recipient 101.

After receiving the call setup information, the relay agent 126 or 136 may create a video call to the video phone 125A and/or chat session to the computing device 125B of the hearing impaired user 125 and an outbound voice call to the intended voice call recipient 101.

In some embodiments, the relay agent 126 or 136 initiates a video link to the video device 125A and/or a chat session to the computing device 125B of the hearing impaired person 125 via the network 109 or 122. The relay agent 126 or 136 may place an outcall to the desired recipient 101 of the call using the PSTN 108. These calls may be based on automated information provided by the NTS server 113, or by communication with the hearing impaired person 125 via the video link (e.g., via the video phone 125A). Similarly, where the intended recipient is reachable via an Internet communication service 122 or 124 (e.g., Skype®, VOIP, or the like), the relay agent 126 or 136 may establish a connection to the user 122 or 124 via the selected communication service using the network 109.

In other embodiments, the NTS server 113 dials out to the voice call recipient 101 and to the selected relay agent 126 or 136, and then signals to PSTN network 108 to link these two calls together via an ISDN “TBCT” operation or similar technique. In another embodiment, the NTS server 113 hosts an n-way audio conference call between the voice recipient 101, the relay agent 126 or 136, and one or more hearing impaired persons 125 substantially as described above.

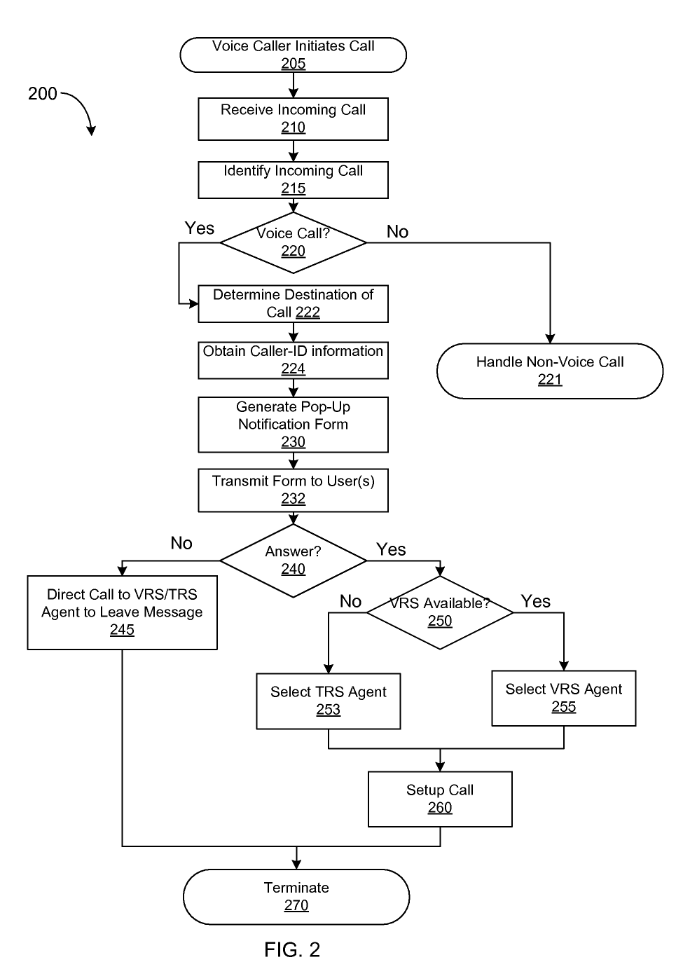

FIG. 2 is a flow diagram of one embodiment of a method 200 for providing calling services to a hearing impaired call recipient. The call may be initiated by entering a number (e.g., a One-Nbr described above) associated with a particular user or group of users. At step 205, a caller may initiate a call to an NTS user. The call may be initiated on a PSTN network 118, a wireless network (not shown), or any other communications network known in the art (e.g., an Internet communications network, a VOIP network, or the like).

At step 210, the call may be received. As discussed above, the receiving of step 210 may comprise routing the voice call to an NTS server, such as the NTS server 113 described above in conjunction with FIG. 1 using a PBX. Alternatively, or in addition, the incoming call of step 210 may be received from an Internet phone (e.g., VOIP, Skype®, or the like). The NTS server of step 210 may be associated with a number dialed by the caller (or other network identifier provided by the caller) at step 205. The routing may be based on the number or network identifier dialed at step 205.

Responsive to receiving the incoming call, an incoming call script may be invoked to handle the call. The script may comprise identifying the nature of the incoming call at step 215. The identifying of step 215 may comprise determining whether the incoming call is a voice call, a fax call, a TTY call, or the like. As discussed above, the identifying of step 215 may comprise identifying the call based on a tone detected on the incoming call. In some embodiments, the method 200 may prompt the caller for identification information (e.g., prompt the caller to provide an input, such as voice input or the like to allow the call to be identified). In addition, at step 220, the caller may be informed (via a voice prompt or the like) that the call has been received and is being processed by method 200.

At step 220, method 200 may determine whether the incoming call is a voice call or another call type. If the call is a voice call, the flow may continue to step 222; otherwise, the flow may continue to step 221 where the non-voice call may be processed.

At step 221, a non-voice call may be processed. Method 200 may be configured to handle may different types of incoming calls, such as fax calls, TTY calls, and the like. Although not shown in FIG. 2, method 200 may handle an incoming fax call by receiving the fax call data and storing the fax data in a user or user group mailbox (e.g., as a graphical image, PDF, or the like). The user may be provided access to the mailbox via a software application or the like. Also, not shown in FIG. 2, a TTY call may be routed directly to the user (provided the user has the proper equipment for receiving the TTY call).

At step 222, the call destination may be determined. The call destination may be determined by accessing one or more look-up tables or other data stores relating the number dialed at step 205 to one or more potential call recipients. Accordingly, the information may include the recipient's phone number, a group phone number, or the like. As discussed above, the determining of step 222 may comprise consulting a lookup-table, datastore, or other data storage system (e.g., a database, internal table, memory, or the like) to determine the destination of the call. Accordingly, the method 200 may comprise an alternative routing scheme from the phone number used to initiate the call (e.g., may comprise additional extensions to the phone number or the like).

At step 224, information identifying the caller (e.g., the user who initiated the call at step 205) may be obtained. The caller information of step 224 may be based on caller-ID information stored in one or more public or private databases. In addition, the method 200 may comprise a datastore configured to hold caller identification information.

At step 230, the information obtained at step 222 and 224 may be used to generate a One-Nbr pop-up prompt. The prompt may comprise the caller-ID information associated with the incoming call (e.g., “Incoming call from John Doe”). The caller-ID information displayed on the prompt may comprise any identification information known in the art including, but not limited to: a name of the caller; a graphical representation of the caller (e.g., photo, avatar, or the like); an address or locale of the caller, or the like.

At step 232, the prompt generated at step 230 may be transmitted to one or more recipients of the call (e.g., the recipients identified at step 222). The transmission of step 232 may comprise transmitting a message over a network, such as a local area network (LAN), wide area network (WAN), the Internet, or the like. The one or more users may have one or more respective computing devices configured to receive notifications from the method 200. The devices may comprise computing devices, such as personal computers, PDAs, smartphones, or the like. The notification may cause a pop-up message to be displayed on the respective computing devices.

Although not shown in FIG. 2, if one or more of the recipients is capable of receiving a voice call, a prompt to answer the voice call (e.g., a ring or the like) may be directly routed to a voice call receiver (e.g., telephone) of such users.

The prompt transmitted at step 232 may comprise one or more inputs to allow a recipient of the call to selectively answer or otherwise handle the call. For example, the prompt may allow a user to ignore the call, transfer the call to a messaging service, to answer the call, or the like.

In addition, the prompt may provide answer options to the user. For example, the user may be presented with an option of answering the call using VRS services (e.g., use a VRS agent to act as an intermediary between the hearing impaired user and the voice caller), answering the call using TRS services (e.g., use a text relay agent), or the like.

At step 240, if the user indicates he/she would like to answer the call using a relay agent, the flow may continue to step 250. Otherwise, if the user does not answer the call or indicates he/she would like to transfer the call to a messaging service, the flow may continue at step 245.

At step 245, the call may be handled by a messaging service. This may comprise connecting the incoming call to a relay agent (e.g., a VRS or TRS relay agent) who may take the message for the user. For example, a VRS agent may translate a voice message from the caller into a video message, which may be stored in a user or user group level message in box for later access by the user or group of users. A TRS agent may transcribe a voice message into a text message, which may be stored in a user or user group level message box for later access by the user or group of users. After leaving the message, the flow may terminate at step 270.

At step 250, the method may determine whether VRS services are available. As discussed above, method 200 may limit the number of concurrent VRS calls (e.g., due to, inter alia, bandwidth, and/or QOS constraints). If a threshold number of calls are already in progress, the flow may continue to step 255, where the user may be transferred to a TRS agent. If there are sufficient resources to service the VRS call, the flow may continue to step 260.

Although step 250 is shown as occurring after step 230 (where the pop-up notification is generated), in some embodiments, the method 200 may determine whether VRS services are available before generating the pop-up. In such embodiments, the pop-up prompt may indicate whether VRS calling services are available. If VRS services are not available, the prompt may so indicate with a disabled VRS input or other message.

At step 245, a TRS agent to handle the incoming call may be identified. The TRS agent may be an in-house TRS agent or may be a remote TRS agent provided by a remote, third-party provider. After identifying a TRS agent for the call, the flow may continue to step 260.

At step 250, a VRS agent may be identified. As above, the VRS agent may be an in-house VRS agent or may be a remote VRS agent provided by a third-party provider. After identifying a VRS agent for the call, the flow may continue to step 265.

At step 260, a call between the receiver (e.g., the hearing impaired recipient of the call), the initiating caller, and the relay agent may be established.

If VRS services are in use, a video call may be established between the hearing impaired recipient of the call and the VRS agent. The VRS agent may also be connected to the caller via a phone or other auditory connection. In this way, the VRS agent may receive voice communications from the caller, which may be translated by the VRS agent into a sign language equivalent for the hearing impaired call recipient. Similarly, the VRS agent may translate sign language communications from the hearing impaired call recipient into voice communications for the caller.

If TRS services are in use, a text chat session may be established between the hearing impaired recipient of the call and the TRS agent. The TRS agent may be connected to the caller via a phone or other auditory connection. In this way, the TRS agent may receive voice communications from the caller, which may be translated by the TRS agent into text for the hearing impaired call recipient. Similarly, the TRS agent may translate text communications received from the hearing impaired call recipient into voice communications for the caller.

As discussed above, although not shown in FIG. 2, in some embodiments a VRS and TRS agent may be used. In this way, a video and/or text transcript of the communication may be made available to the call receipt and/or caller.

Establishing a connection at step 260 may comprise hosting an n-way conference call comprising one or more video channels and one or more voice (telephone) communications channels. As described above, establishing a connection may comprise transmitting caller-ID information to the VRS or TRS agent, automatically transferring one or more calls using an ISDN TCBT technique, or the like.

After establishing the connection between the caller, the hearing impaired call recipient, and the VRS or TRS agent, the flow may terminate step 270.

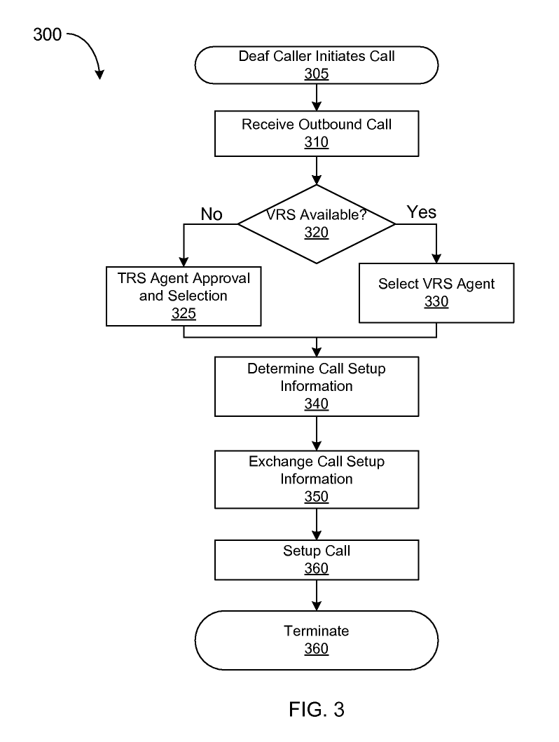

FIG. 3 is a flow diagram of one embodiment of a method 300 for providing outcall services for hearing impaired caller.

At step 305, the hearing impaired caller may initiate an outbound call. Initiating an outbound call may comprise accessing a contacts list, address book, or other software application provided on a computing device (e.g., video phone, personal computer, or the like) communicatively coupled to the method 300. The call may be initiated by selecting a particular entry in an application. Selection of the entry may cause the software application to transmit an outbound call request to method 300. The request may be transmitted using any communications network known in the art including, but not limited to a LAN, WAN, Internet, or the like.

At step 310, the outbound call request may be received. Receiving the request may comprise determining a destination for the call (e.g., a phone number associated with the request) or the like.

At step 320, the availability of VRS services may be determined. As discussed above, in some embodiments the number of concurrent VRS calls serviced by the method 300 may be limited. At step 320, if the limit has not been exceeded, a VRS call may be allowed and the flow may continue to step 330; otherwise, the flow may continue to step 325.

At step 325, the caller may be informed that no VRS services are available at the time. In some embodiments, the caller may be prompted to discontinue the call and try again later. The user may be informed that if the call is continued, it may be serviced using a TRS agent, rather than using video. In addition, at step 325, an available TRS agent may be identified. The TRS agent may be an in-house agent or a remote, third-party TRS agent. After identifying the TRS agent, the flow may continue to step 340.

At step 330, a VRS agent available to service the call may be identified. As discussed above, the VRS agent may be an in-house VRS agent or a remote, third-party VRS agent. After identifying the VRS agent, the flow may continue to 330.

At step 340, method 300 may provide the VRS/TRS agent with call setup information. In other embodiments, the method 300 may be configured to setup the call. In these embodiments, the VRS/TRS agent may be included in the call without necessitating the information exchange at step 340.

At step 350, an n-way call between the outbound caller, the VRS/TRS agent, and the recipient of the call may be established. If TRS services are used, the connection between the hearing impaired caller and the TRS agent may comprise a text chat channel. If VRS services are used, the connection between the hearing impaired caller and the VRS agent may comprise a video phone connection. The VRS/TRS agent may be connected to the recipient of the call using a phone connection via a PSTN network, wireless network, VOIP network, or the like. After setting up the call, the flow may terminate at step 360.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable medium having stored instructions thereon that may be used to program a computer (or other electronic device) to perform processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention.

I claim:

1. A computer-readable storage medium comprising instructions to cause a computing device to perform a method for providing communications services, the method comprising:
receiving a call from a caller;
identifying an intended recipient of the call, wherein the intended recipient is hearing impaired;
transmitting an incoming call prompt to the intended recipient, wherein the prompt comprises an input to allow the intended recipient to answer the call;
receiving a request to answer the call from the intended recipient;
selecting one of a plurality of human relay agents to service the call;
establishing a connection between the intended recipient and the selected relay agent and a connection between the selected relay agent and the caller.

2. The computer-readable storage medium of claim 1, wherein the intended recipient is a hearing impaired person, and wherein the connection between the intended recipient and the selected relay agent is configured to allow the selected relay agent to translate between the caller and the intended recipient.

3. The computer-readable storage medium of claim 1, wherein the method further comprises:
receiving a request to take a message from the incoming call from the intended recipient;
selecting one of a plurality or relay agents to take a message from the incoming call; and
establishing a connection between the caller and the selected relay agent, wherein the connection is configured to allow the relay agent to receive and translate a message from the caller and to store the translation in a messaging service.

4. The computer-readable storage medium of claim 1, wherein the intended recipient of the call comprises a group of intended recipients comprising one or more hearing persons and one or more hearing impaired persons, and wherein transmitting an incoming call prompt to the intended recipient comprises transmitting a prompt to each of the one or more hearing persons and a prompt to each of the one or more hearing impaired persons in the group of intended recipients.

5. The computer-readable storage medium of claim 1, wherein the server is communicatively coupled to a private branch exchange (PBX) communicatively coupled to a public switched telephone network (PSTN), and wherein receiving the call from the caller comprises receiving a voice call made on the PSTN routed through the PBX.

6. The computer-readable storage medium of claim 1, wherein the method further comprises:
obtaining caller identification information related to the caller; and
generating the incoming call prompt responsive to the incoming call, wherein the prompt comprises the caller identification information.

7. The computer-readable storage medium of claim 1, wherein the incoming call prompt is adapted for display on a computing device of the intended recipient.

8. The computer-readable storage medium of claim 7, wherein the incoming call prompt is adapted to be displayed on a mobile computing device of the intended recipient.

9. The computer-readable storage medium of claim 1, wherein establishing the connection between the caller and the relay agent comprises:
providing a call back number to the selected relay agent, wherein the call back number is mapped to the call received from the caller;
receiving a call from the selected relay agent on the call back number; and
linking the call from the selected relay agent to the call received from the caller.

10. The computer-readable storage medium of claim 9, wherein linking the call from the selected relay agent to the call received from the caller comprises hosting a conference call between the selected relay agent and the caller.

11. The computer-readable storage medium of claim 9, wherein linking the call from the selected relay agent to the call received from the caller comprises linking the calls using a Two B Channel Transfer technique.

12. The computer-readable storage medium of claim 1, wherein the method further comprises transferring the call received from the caller to the selected relay agent.

13. The computer-readable storage medium of claim 12, wherein the computing device of the intended recipient comprises a video phone, and wherein the video phone of the intended recipient contacts a video phone of the selected relay agent using the network address of the selected relay agent.

14. The computer-readable storage medium of claim 12, wherein the computing device of the intended recipient comprises a text chat application, and wherein the text chat application of the intended recipient contacts a text chat application of the selected relay agent using the network address.

15. The computer-readable storage medium of claim 1, wherein the method further comprises:
determining a number of concurrent active video relay connections;
comparing the number of active video relay connections to a threshold value; and
disabling video relay services for the incoming call if an additional video relay connection would exceed the threshold value.

16. The computer-readable storage medium of claim 1, wherein the method further comprises determining whether the incoming call is a voice call or another call type.

17. The computer-readable storage medium of claim 16, wherein determining the call type comprises detecting a tone on the call.

18. The computer-readable storage medium of claim 16, wherein determining the call type comprises transmitting a signal on the call to solicit a response on the call.

19. The computer-readable storage medium of claim 16, wherein identifying the call type comprises determining that the incoming call is a fax call.

20. The computer-readable storage medium of claim 16, the method further comprising:
determining that the incoming call is a fax call;
receiving fax data from the fax call; and
storing the fax data in a message box of the intended recipient of the call.

21. A system for providing communication services, comprising:
a server; and
a plurality of relay agents communicatively coupled to the server;
wherein the server comprises
a call reception component to receive a call from caller and to determine an intended recipient of the call from one or more users communicatively coupled to the server, wherein said intended recipient is hearing impaired,
a prompt component to generate an incoming call prompt comprising information identifying the caller and to transmit the incoming call prompt to the intended recipient of the call for display on a computing device of the intended recipient,
a call setup component to, responsive an indication from the intended recipient that the intended recipient wishes to answer the call, select one of the plurality of human relay agents to service the call and establish a connection between a video phone of the intended recipient of the call and a video phone of the selected relay agent.

22. A computer-readable storage medium comprising instructions to cause a computing device to perform a method for providing communications services to the one or more users, the method comprising:
receiving a request from a user of the one or more users to place a call to a voice call recipient, wherein the user is hearing impaired;
selecting one of a plurality of human relay agents to service the call request;
establishing a connection between the particular user and the selected relay agent, wherein the connection comprises one selected from a video phone connection and a text chat connection; and
establishing a connection between the selected relay agent and an intended voice call recipient, wherein establishing a connection between the selected relay agent and an intended voice call recipient comprises
establishing a voice call to the voice call recipient,
establishing a voice call to the selected relay agent, and
linking the voice call to the voice call recipient with the voice call to the selected relay agent.
